(19) United States
(12) Patent Application Publication
(10) Pub. No.: US 2009/0197009 A1
(43) Pub. Date: Aug. 6, 2009

(54) METHOD OF PRODUCING FILTER AND METHOD OF PRODUCING LIQUID TRANSPORTING APPARATUS

(75) Inventor: Hiroto SUGAHARA, Aichi-ken (JP)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(73) Assignee: BROTHER KOGYO KABUSHIKI KAISHA, Nagoya-shi (JP)

(21) Appl. No.: 12/364,503

(22) Filed: Feb. 2, 2009

(30) Foreign Application Priority Data
Feb. 5, 2008 (JP) 2008-025350

(51) Int. Cl. B05D 3/06; B05D 5/00; B05D 5/06

(52) U.S. Cl. 427/521; 427/244; 427/100

(57) ABSTRACT

Droplets of an ultraviolet-curing resin are jetted on to a cavity plate included in a stacked body, and the droplets are cured by irradiating ultraviolet rays. Next, a vibration layer is formed on the cavity plate by an AD method. Further, a common electrode is formed on the vibration layer, and a mask is arranged on the vibration layer. Next, a piezoelectric layer is formed on the vibration layer, and thereafter, the mask is removed. Further, a through hole and pressure chambers are formed by removing parts of the cavity plate. Thereafter, individual electrodes are formed on the piezoelectric layer, and by heating the stacked body at about 850° C., annealing of the piezoelectric layer and sintering of the electrodes are performed. Accordingly, an ink-jet head including a filter which has a low channel resistance is manufactured.

### CROSS REFERENCE TO RELATED APPLICATION

The present application claims priority from Japanese Patent Application No. 2008-025350, filed on Feb. 5, 2008, the disclosure of which is incorporated herein by reference in its entirety.

### BACKGROUND OF THE INVENTION

1. Field of the Invention

The present invention relates to a method of producing a filter which removes impurities in a liquid, and a method of producing a liquid transporting apparatus having such filter.

2. Description of the Related Art

In an ink-jet head described in Japanese Patent Application Laid-open Publication No. 2004-268454, a piezoelectric actuator is arranged on an upper surface of a channel unit which is formed by stacking a plurality of plates. A plurality of pressure chambers cut through a direction of thickness of a base plate is formed in the base plate in the channel unit. Furthermore, a plurality of filter holes is formed in the base plate, at locations different from locations at which the pressure chambers are formed. The filter holes form a filter for removing impurities in an ink which might enter a manifold channel. Moreover, such filter is formed by an electroforming (electrocasting). In other words, after forming a resist pattern corresponding to the filter holes on a surface of an electroconductive substrate, a metal film is formed by depositing a metal such as nickel or copper by electroplating on a portion of the substrate on which the resist pattern is not formed, and finally, the filter is formed by removing the substrate from a metal film.

### SUMMARY OF THE INVENTION

However, as described in Japanese Patent Application Laid-open No. 2004-268454, in a case of forming the filter by electroforming, a thickness of the deposited metal film becomes substantial, and a depth of the filter holes also becomes deep (substantial). As a result, a channel resistance of the ink in the filter holes becomes high.

An object of the present invention is to provide a method of producing a filter having a low channel resistance, and a method of producing a liquid transporting apparatus having such filter.

According to a first aspect of the present invention, there is provided a method of producing a filter including

providing a substrate;

forming a plurality of film-formation inhibitory areas, one surface of the substrate, to be scattered in a predetermined area of the one surface, the film-formation inhibitory areas inhibiting a formation of a film which is formed of fine particles contained in aerosol when the aerosol containing the fine particles is blown onto the predetermined area;

forming the film with the fine particles on the one surface of the substrate by blowing the aerosol onto the predetermined area on the one surface of the substrate after the film-formation inhibitory areas are formed; and

removing a portion, of the substrate, facing the predetermined area after forming the film of the fine particles.

According to the first aspect of the present invention, when the film formation is carried out by an aerosol deposition method (AD method) in which a film is formed by spraying aerosol including fine particles on a substrate, the film is formed only on a portion of the one surface of the surface, excluding the film-formation inhibitory areas. Therefore, a filter is made by through holes being formed in a portion, of the film, facing the film-formation inhibitory areas formed. Moreover, it is possible to form a thin film by the film formation using the AD method, and when the film is thin, a depth of the through holes becomes small. Accordingly, producing of a filter having a low channel resistance becomes possible.

Moreover, in the method of producing the filter according to the present invention, each of the film-formation inhibitory areas may be circular shaped. In this case, it is possible to make circular a shape of an opening of each of the through holes which form the filter, and to make uniform a flow velocity of a liquid flowing through the through holes.

In the method of producing the filter according to the present invention, when the film-formation inhibitory areas are formed, the film-formation inhibitory areas may be formed by landing a plurality of liquid droplets onto the one surface of the substrate. In this case, when the liquid droplets are jetted on to the surface of the substrate, the liquid droplets adhered to the surface of the substrate become circular, and on the surface of the liquid droplets, the fine particles adhered are inhibited from becoming a film. Therefore, it is possible to form easily the circular shaped film-formation inhibitory areas. Moreover, by making small a diameter of the liquid droplets jetted, it is possible to form the film-formation inhibitory areas having a small diameter, and accordingly, a diameter of the through holes becomes small, and it is possible to form a filter which is capable of removing small impurities.

In the method of producing the filter according to the present invention, the liquid droplets may be curable (can be hardened). In this case, by curing (hardening) the liquid droplets jetted on to the surface of the substrate, a process thereafter can be carried out easily.

The method of producing the filter according to the present invention may further include irradiating a light on the liquid droplets landed onto the one surface of the substrate, wherein the liquid droplets are photo-curable. In this case, the liquid droplets of photo-curable are jetted onto the surface of the substrate, and the light is irradiated on the liquid droplets jetted on to the surface of the substrate. Therefore, it is possible to cure (harden) easily the liquid droplets on the surface of the substrate.

In the method of producing the filter according to the present invention, the liquid droplets may have a diameter of approximately 10 μm when the liquid droplets are landed. In this case, since it is possible to make the diameter of the through holes which form the filter to be about 10 μm, it is possible to form a filter which is capable of trapping small impurities.

In the method of producing the filter according to the present invention, when the film-formation inhibitory areas are formed, a plurality of areas having a rough surface may be formed on the one surface of the substrate by irradiating a laser ray on the one surface of the substrate. In this case, by irradiating (making irradiate) the laser light on the surface of the substrate, it is possible to make substantial the roughness of the surface of the substrate easily.

In the method of producing the filter according to the present invention, a plurality of areas having a hardness lower than a hardness of the one surface of the substrate may be formed, as the film-formation inhibitory areas, on the one surface of the substrate. For instance, by applying an oil (oil having a low volatility such as machine oil and rotary oil) on the surface of the substrate on which the liquid droplets are to be made to land, it is possible to form areas having a hardness lower than the hardness of the substrate, and to use as the film-formation inhibitory areas.

According to a second aspect of the present invention, there is provided a method of producing a liquid transporting apparatus which includes a channel unit including a pressure chamber plate in which a pressure chamber having an opening formed on one surface of the pressure chamber plate, and a liquid channel having an opening formed on the one surface, and communicating with the pressure chamber are formed;

a piezoelectric actuator which applies a pressure to a liquid in the pressure chamber, and which includes a vibration layer covering the opening of the pressure chamber, a piezoelectric layer arranged on the vibration layer on a side not facing the pressure chamber, and an electrode which is arranged on a portion, of the piezoelectric layer, facing the pressure chamber; and

a filter which covers the opening of the liquid channel, and which removes impurities in the liquid to prevent the impurities from entering into the liquid channel,

the method of producing the liquid transporting apparatus including:

providing the pressure chamber plate;

forming a plurality of film-formation inhibitory areas on one surface of the pressure chamber plate to be scattered on an area, of the one surface, facing the liquid channel, the film-formation inhibitory areas inhibiting formation of a film which is formed of fine particles contained in an aerosol when the aerosol containing the fine particles is blown onto the one surface of the pressure chamber plate;

forming the vibration layer after the film-formation inhibitory areas are formed, by blowing the aerosol including the fine particles as a material forming the vibration layer, on the one surface of the pressure chamber plate, onto an area facing the pressure chamber and the liquid channel;

forming the pressure chamber and the liquid channel to penetrate through the pressure chamber plate, after the vibration layer is formed, by removing a part of the pressure chamber plate;

forming the piezoelectric layer on the vibration plate, on a side not facing the pressure chamber plate; and

forming the electrode on a portion, of the piezoelectric layer, facing the pressure chamber.

According to the second aspect of the present invention, when the film formation is carried out on the one surface of the pressure chamber plate by the aerosol deposition method (AD method) in which the film is formed by spraying aerosol including fine particles of a material which forms the vibration layer on a substrate, the film is formed only on a portion of the one surface of the pressure chamber plate, excluding the film-formation inhibitory areas. Accordingly, a portion of the film formed, facing the pressure chamber becomes the vibration layer, and a portion of the film facing the liquid channel becomes a filter having a large number of (a plurality of) holes formed in the portion facing the film-formation inhibitory areas. Moreover, in the film formation in which the AD method is used, it is possible to form a film of the filter and a thin vibration layer, and when this film is thin, a depth of the through holes of the filter becomes small. Accordingly, producing of a filter having a small (low) channel resistance becomes possible.

Moreover, since it is possible to form the vibration layer and the filter simultaneously as it has been described above, a process of producing the liquid transporting apparatus becomes simple.

In the method of producing the liquid transporting apparatus according to the present invention, the piezoelectric layer may be formed on the vibration layer so as to avoid a portion, of the vibration layer, which faces the liquid channel, and which is disposed on a side not facing the pressure chamber plate.

In a case of forming the piezoelectric layer on a portion of the vibration layer facing the liquid channel, on the side not facing the pressure chamber plate, for making the liquid channel communicate with an opposite side of the filter, holes are to be formed in a portion of the piezoelectric layer, facing the film-formation inhibitory areas. Therefore, in this case, a stacked structure of the piezoelectric layer and the vibration plate in which the holes are formed at the portions facing the film-formation inhibitory areas becomes the filter, and a depth of the holes of the filter becomes deep by an amount of thickness of the piezoelectric layer, and a channel resistance of the through holes becomes substantial. However, in the present invention, since the piezoelectric layer is formed avoiding the portion of the vibration layer facing the liquid channel, the holes of the filter do not become deep, and the channel resistance doesn't becomes substantial (high).

In the method of producing the liquid transporting apparatus according to the present invention, the piezoelectric layer may be formed on the vibration layer by blowing an aerosol containing fine particles of a piezoelectric material on the vibration layer, on a side not facing the pressure chamber plate.

Accordingly, in a case of forming the piezoelectric layer by using the AD method, by spraying aerosol after masking the portion facing the liquid channel, or, by spraying aerosol avoiding the portion facing the liquid channel, it is possible to form the piezoelectric layer easily, avoiding the portion facing the liquid channel. Moreover, by the AD method, it is possible to form at a high speed, a piezoelectric layer having a highly dense structure.

In the method of producing the liquid transporting apparatus according to the present invention, when the piezoelectric layer is formed, the aerosol containing the fine particles of the piezoelectric material may be blown after masking a portion, of the vibration layer, which faces the liquid channel, and which is disposed on a side not facing the pressure chamber plate.

In a case of forming the piezoelectric layer by the AD method, by spraying aerosol including the fine particles of the piezoelectric material after masking the portion of the vibration layer, facing the liquid channel, it is possible to form the piezoelectric layer easily, avoiding the portion facing the liquid channel, without carrying out a control of locations at which the aerosol is sprayed.

Moreover, in the method of producing the liquid transporting apparatus according to the present invention, the pressure chamber and the liquid channel may be formed simultaneously in the pressure chamber plate by removing the part of the pressure chamber plate by an etching.

Accordingly, since it is possible to form the pressure chamber and the liquid channel simultaneously in the pressure chamber plate, a step of removing the part of the pressure chamber plate becomes simple.

In the method of producing the liquid transporting apparatus of the present invention, the pressure chamber plate may be formed of one of stainless steel and silicon. In this case, it is possible to form the pressure chamber and the liquid channel by removing the part of the pressure chamber plate easily by etching.

In the method of producing the liquid transporting apparatus of the present invention, the piezoelectric layer, the electrode, and the pressure chamber plate may be heated to a temperature of about 850° C. after forming the piezoelectric layer, the electrode, the pressure chamber and the liquid channel. In this case, at the time of annealing the piezoelectric layer, it is possible to bake the electrode simultaneously. Moreover, since the piezoelectric layer etc. are heated after the pressure chamber etc. is formed, there is no possibility of atoms forming the pressure chamber being scattered (diffused) in an area overlapping with the pressure chamber, and there is no possibility that piezoelectric characteristics of the area of the piezoelectric layer, overlapping with the pressure chamber are declined.

According to the method of producing the filter according to the present invention, since it is possible to form a filter of a thin film having a small depth of the through holes, it is possible to provide a filter having a small (low) channel resistance.

Moreover according to the method of producing the liquid transporting apparatus of the present invention, since it is possible to form a liquid transporting apparatus including the filter of a thin film having a small depth of the through holes, as the filter which removes impurities in the liquid which might enter the liquid channel, it is possible to provide the liquid transporting apparatus which includes the filter having a small (low) channel resistance.

### BRIEF DESCRIPTION OF THE DRAWINGS

FIG. 1 is a schematic structural view of a printer according to an embodiment of the present invention;

FIG. 2 is a plan view of an ink-jet head in FIG. 1;

FIG. 3 is a partially enlarged view of FIG. 2;

FIG. 4 is a cross-sectional view taken along a line IV-IV in FIG. 3;

FIG. 5 is a cross-sectional view taken along a line V-V in FIG. 3;

FIG. 6 is a cross-sectional view taken along a line VI-VI in FIG. 2;

FIG. 7 is a flowchart showing a producing process of an ink-jet head;

FIGS. 8A, 8B, 8C, 8D and 8E are diagrams each showing a step of producing the portion, of the ink-jet head, corresponding to FIG. 4; and

FIGS. 9A, 9B, 9C, 9D, 9E and 9F are diagrams each showing a step of producing the portion, of the ink-jet head, corresponding to FIG. 6.

### DETAILED DESCRIPTION OF THE PREFERRED EMBODIMENTS

An exemplary embodiment of the present invention will be described below.

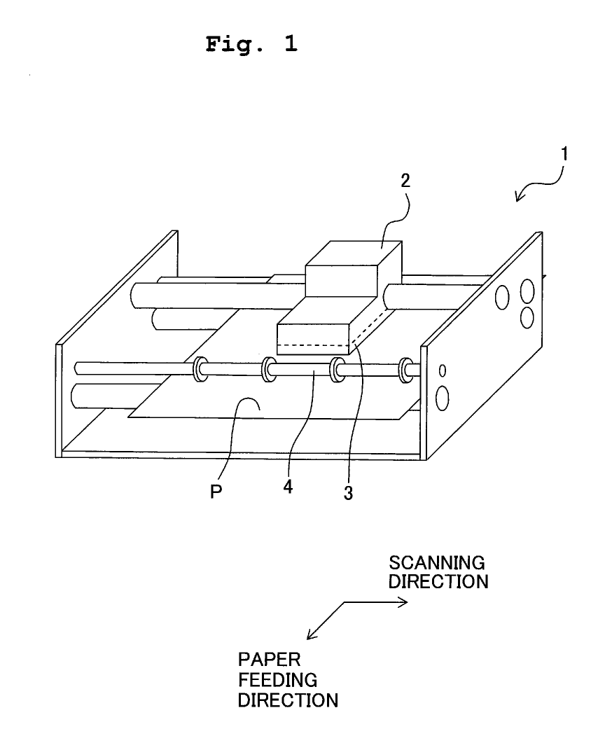

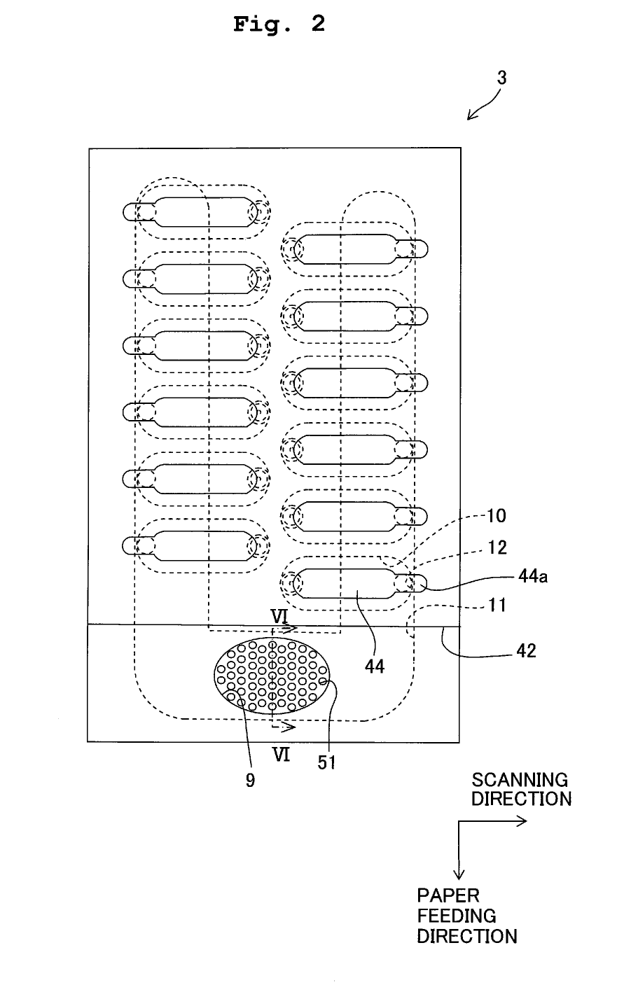

FIG. 1 is a schematic structural view of a printer according to an embodiment. As shown in FIG. 1, a printer 1 includes a carriage 2, an ink-jet head 3, and a transporting roller 4. The carriage 2 reciprocates in a scanning direction (left-right direction in FIG. 1). The ink-jet head 3 is installed on a lower surface of the carriage 2, and jets an ink from a plurality of nozzles 15 formed in a lower surface thereof (refer to FIG. 2) while reciprocating in the scanning direction along with the carriage 2. The transporting roller 4 transports a recording paper P in a paper feeding direction (frontward direction in FIG. 1). Moreover, in the printer 1, the printing is carried out on the recording paper P by jetting the ink, onto the recording paper P which is transported in the paper feeding direction by the transporting roller 4, from the ink-jet head 3 which reciprocates in the scanning direction together with the carriage 2.

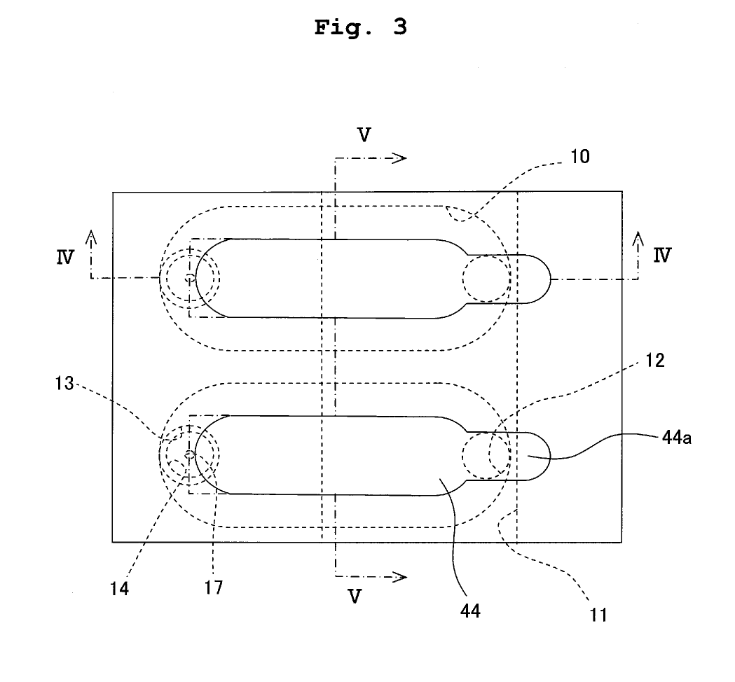

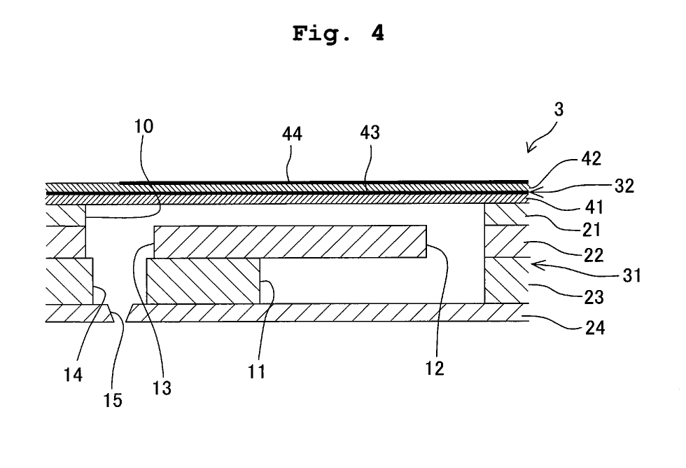

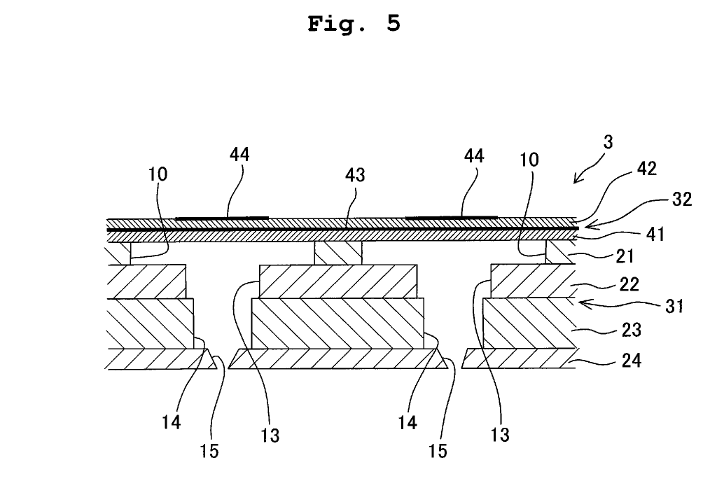

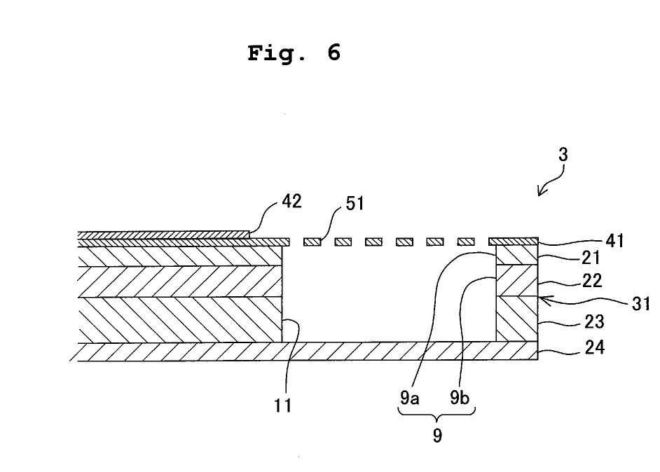

Next, the ink-jet head 3 will be described below. FIG. 2 is a plan view of the ink-jet head 3 in FIG. 1. FIG. 3 is a partially enlarged view of FIG. 2. FIG. 4 is a cross-sectional view taken along a IV-IV line in FIG. 3. FIG. 5 is a cross-sectional view taken along a V-V line in FIG. 3. FIG. 6 is a cross-sectional view taken along a VI-VI line in FIG. 2. As shown in diagrams from FIGS. 2 to 6, the ink-jet head 3 includes a channel unit 31 in which ink channels such as pressure chambers 10 are formed, and a piezoelectric actuator 32 which applies a pressure to the ink in the pressure chamber 10.

The channel unit 31 includes a cavity plate 21, a base plate 22, a manifold plate 23, and a nozzle plate 24, and these four plates are stacked mutually. Among these four plates 21 to 24, the three plates 21 to 23 except the nozzle plate 24 are formed of a metallic material such as stainless steel, and the nozzle plate 24 is formed of a synthetic resin such as polyimide. Or, the nozzle plate 24 may also be formed of a metallic material similarly as the other three plates.

A plurality of pressure chambers 10 is formed in the cavity plate 21 (pressure chamber plate). The pressure chambers 10, in a plan view, have a substantially elliptical shape which is elongated in the scanning direction (left-right direction in FIG. 2; a longitudinal direction), and the pressure chambers 10 are cut through a thickness direction of the cavity plate 21 (the pressure chambers 10 open on one surface of the cavity plate 21). Moreover, the pressure chambers 10 are arranged in two rows in the paper feeding direction (vertical direction in FIG. 2). A through hole 9a forming an ink supply channel 9 is formed at a lower-end portion in FIG. 2 of the cavity plate 21. The through hole 9a has a substantially elliptical opening in a plan view. The through hole 9a which is cut through the thickness direction of the cavity plate 21 corresponds to a liquid channel according to the present invention which opens on an upper surface (one surface) of the cavity plate 21. Moreover, the through hole 9a communicates with the pressure chambers 10 via a through hole 9b, a manifold channel 11, and through holes 12 which will be described later.

The through holes 12 and through holes 13 having a substantially circular shape are formed in the base plate 22 at positions overlapping with both end portions in the longitudinal direction of the pressure chambers 10 in a plan view, respectively. Moreover, the through hole 9b having a substantially elliptical shape, which forms the ink supply channel 9 is formed in a portion of the base plate 22 overlapping with the through hole 9a in a plan view.

The manifold channel 11 is formed in the manifold plate 23. The manifold channel 11 has two extending portion which are extended in two rows in the paper feeding direction along the row of the pressure chambers 10, and a connecting portion which is extended in the scanning direction to connect the extending portions at a lower-end portion in FIG. 2. The manifold channel 11 is arranged such that one of the extending portions of the manifold channel 11 extended in the paper feeding direction overlaps with a substantial right-half portion of the pressure chambers 10 arranged at a right side of FIG. 2 in a plan view, and the other extending portion overlaps with a substantial left-half portion of the pressure chambers 10 arranged at a left side of FIG. 2. Moreover, a substantially central portion, in the scanning direction, of the connecting portion of the manifold channel 13 (11) extended in the scanning direction faces the through holes 9a and 9b. Accordingly, the ink is supplied to the manifold channel 13 (11) through the ink supply channel 9 formed to make the through hole 9a and the through hole 9b communicate mutually. Moreover, through holes 14 each having a substantially circular-shaped opening are formed in the manifold plate 23, at portions overlapping with the through holes 13 in a plan view. The nozzles 15 are formed in portions of the nozzle plate 24, overlapping with the through holes 14 in a plan view.

The ink channels are formed in the channel unit 31, the ink channels including the ink supply channel 9 which communicates with the manifold channel 11; the manifold channel 11 which communicates with the pressure chambers 10 via the through holes 12; and the pressure chambers 10 which communicate with the nozzles 15 via the through holes 13 and 14.

The piezoelectric actuator 32 includes a vibration layer 41, a piezoelectric layer (a layer which includes a piezoelectric material) 42, a common electrode 43, and a plurality of individual electrodes 44.

The vibration layer 41 is formed of ceramics material such as zirconia, and is arranged on an upper surface of the cavity plate 21 to cover openings of the pressure chambers 10 and openings of the through hole 9a. Furthermore, a plurality of substantially circular shaped through holes 51 cut through a thickness direction of the vibration layer 41, of which diameter is about 10 μm (when viewed from a direction orthogonal to one surface) are arranged to be separated mutually in the vibration layer 41, at a portion facing the through hole 9a. Accordingly, the portion, of the vibration layer 41, facing the through hole 9a covers the opening of the through hole 9a, and functions as a filter for removing impurities in the ink which might enter the ink supply channel 9. In other words, the vibration layer 41 corresponds to a vibration layer according to the present invention which covers the pressure chamber 10, and to a filter according to the present invention which covers the opening of the through hole 9a. In other words, the vibration layer and the filter according to the present invention are formed to be integrated. Moreover, since the through holes 51 which form the filter are substantially circular shaped, a flow velocity of the ink flowing through the through holes 51 becomes uniform.

The piezoelectric layer 42 includes a piezoelectric material having lead zirconate titanate as a main constituent, is a mixed crystalline material of lead titanate and lead zirconate, and is arranged on an upper surface of the vibration layer 41 to be continuously spread over the pressure chambers 10, excluding a lower-end portion in FIG. 2. In other words, the piezoelectric layer 42 is arranged on a surface of the vibration layer 41, on a side opposite to the pressure chamber 10, to be continuously spread over the pressure chambers 10, avoiding the portion facing the through hole 9a. Moreover, the piezoelectric layer 42 is polarized in a thickness direction thereof in advance.

The common electrode 43 is made of a metallic material such as platinum, palladium, gold, and silver, and is arranged to be spreading over almost entire area between the vibration layer 41 and the piezoelectric layer 42. The common electrode 43 is connected to a driver IC which is not shown in the diagram, via a flexible print circuit (FPC) which is not shown in the diagram, and is kept all the time at a ground electric potential by the driver IC.

The individual electrodes 44 are made of a material similar to the material of the common electrode 43, and are arranged corresponding to the pressure chambers 10, on an upper surface of the piezoelectric layer 42. The shape of the individual electrodes 44, in a plan view, is substantially circular and slightly smaller than the pressure chambers 10, and each of the individual electrodes 44 is arranged on a portion, of the piezoelectric layer 42, overlapping with a substantially central portion of one of the pressure chambers 10. Moreover, an end portion of each of the individual electrodes 44, on a side opposite to the nozzles 15 in a longitudinal direction, is drawn in the scanning direction, and is extended up to a portion of the piezoelectric layer 42, not facing the pressure chambers 10. A front-end portion of the extended portion of each of the individual electrodes is a connecting terminal to be connected to the FPC which is not shown in the diagram. A driving electric potential is applied to the individual electrodes 44 from the drive IC not shown in the diagram, via the FPC.

Here, a method of driving the piezoelectric actuator 32 will be described below. In the piezoelectric actuator 32, the individual electrodes 44 are kept at the ground electric potential in advance. Moreover, at the time of driving the piezoelectric actuator 32, a driving electric potential is selectively applied to one of the individual electrodes 44. As the driving electric potential is applied, an electric potential difference is developed between the one of the individual electrodes 44 on the piezoelectric layer 42 to which the driving electric potential is applied and the common electrode 43 which is kept at the ground electric potential, and an electric field in the thickness direction of the piezoelectric layer is generated in a portion (an active portion) of the piezoelectric layer 42 sandwiched between the one of the individual electrodes 44 and the common electrode 43.

Since the direction of the electric field coincides with a polarization direction in which the piezoelectric layer 42 is polarized, the active portion of the piezoelectric layer 42 contracts in a horizontal direction which is orthogonal to the direction of the electric field. With the contraction of this portion of the piezoelectric layer 42, a portion of the piezoelectric layer 42 and the vibration layer 41 facing the pressure chamber 10 is deformed as a whole to form a projection toward the pressure chamber 10. Accordingly, a volume of the pressure chamber 10 is decreased, and a pressure of the ink in the pressure chamber 10 rises. In other words, a pressure is applied to the ink in the pressure chamber 10, and the ink is jetted from the nozzle 15 communicating with the pressure chamber 10.

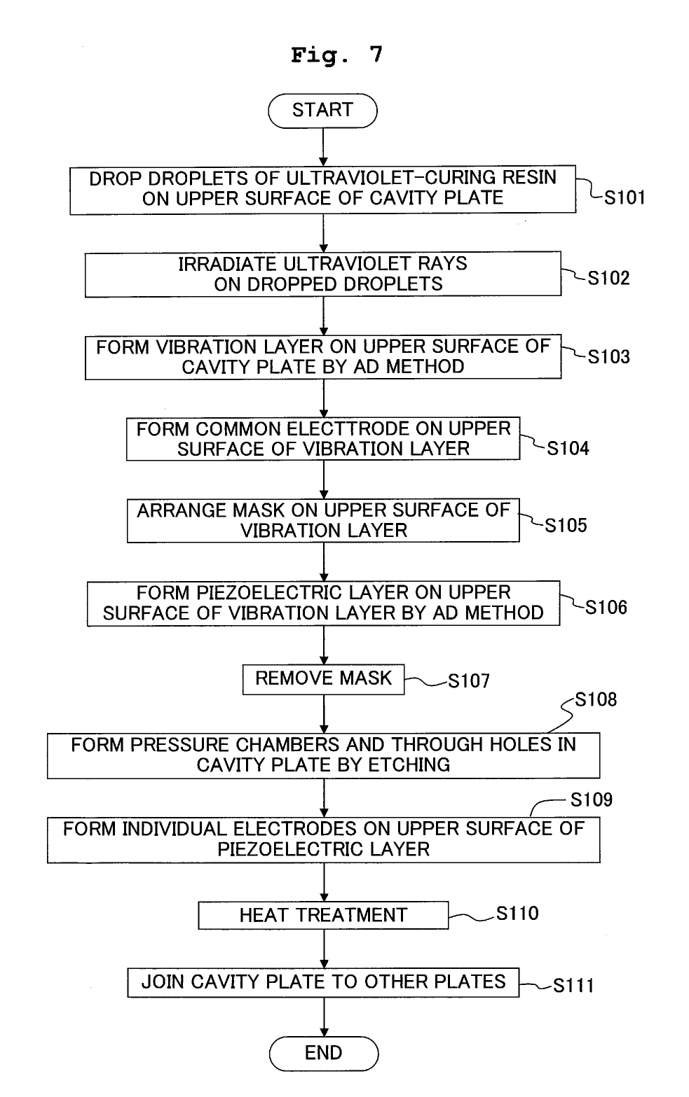

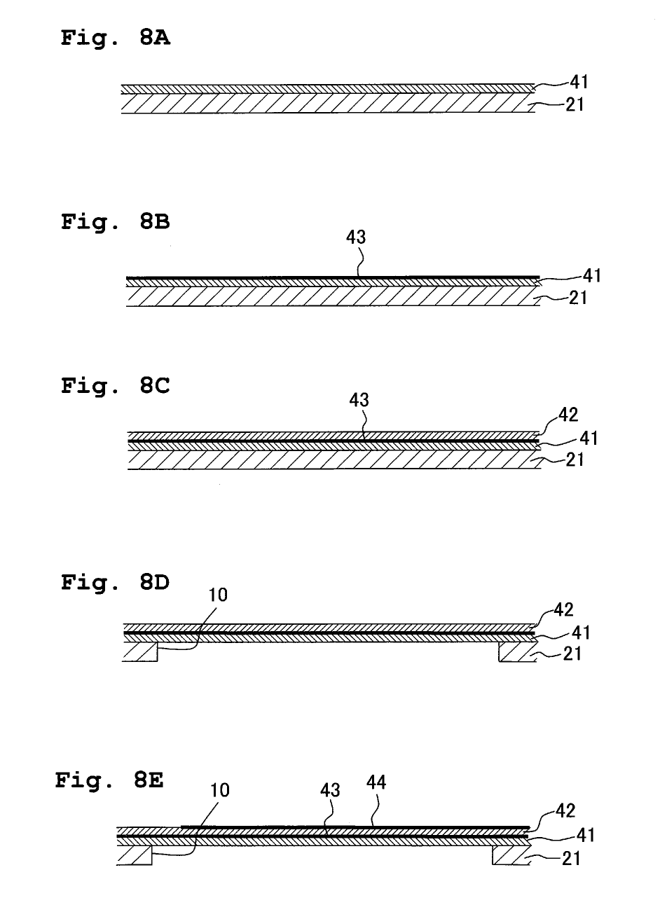

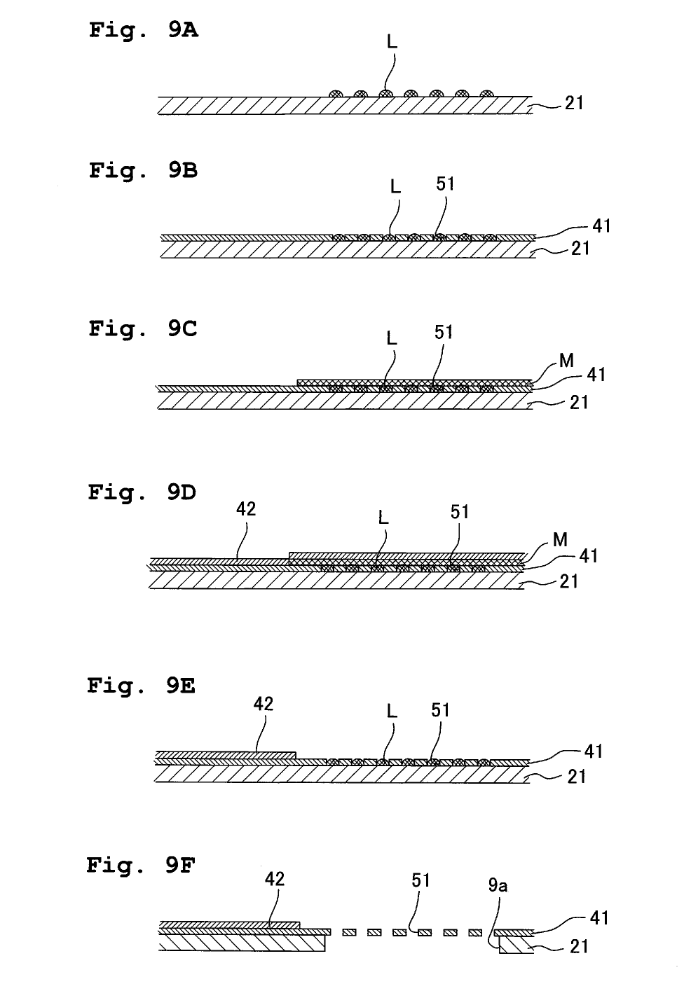

Next, a method of producing the ink-jet head 3 having a filter described above will be described below. FIG. 7 is a flowchart showing a producing process of the ink-jet head 3, and FIG. 8 is a diagram showing a condition of a portion corresponding to FIG. 4 of the ink-jet head 3 in each step of producing. FIG. 9 is a diagram showing a state of a portion corresponding to FIG. 6 of the ink-jet head 3 in each step of producing.

For producing the ink-jet head 3, firstly, as shown in FIGS. 7 and 9A, a plurality of droplets L of an ultraviolet-curing resin is jetted to land on the upper surface (one surface) of the cavity plate 21 before the pressure chambers 10 and the through hole 9a are formed (step S101, step of forming film-formation inhibitory (hindering) area). The ultraviolet-curing resin is an example of photo-curing liquid droplets, and more elaborately, is an example of liquid droplets which can be cured (hardened). It is desirable to jet such droplets L upon adjusting a diameter when landed to about 10 μM.

Next, ultraviolet rays (UV light) are irradiated on the droplets L landed on the upper surface of the cavity plate 21, and the droplets L are cured (hardened) (S102, light irradiation step). In such manner, since the droplets L of the ultraviolet-curing resin are landed on the upper surface of the cavity plate 21, it is possible to cure (harden) the droplets L easily by irradiating the ultraviolet rays on the droplets L. Moreover, since it is possible to make the landed droplets L stay at landing positions by curing by irradiating the ultraviolet rays on the droplets L, it is possible to form the through holes 51 correctly to a desired size in the following steps.

Here, the droplets L landed and cured on the upper surface of the cavity plate 21 have a hardness lower than a hardness of the cavity plate 21 made of a stainless steel. Consequently, portions on which the droplets L are landed are arranged at an interval on the upper surface of the portion of the cavity plate 21 in which the through hole 9a is to be formed (in an area facing the liquid channel on one surface of a substrate, in a predetermined area). The portions, of the upper surface of the cavity plate 21, on which the droplets are landed become areas each of on which fine particles in aerosol are hardly formed when the aerosol is sprayed, than the other portion on the upper surface of the cavity plate 21. In this manner, in the present invention, at the time of film forming on a substrate (cavity plate 21) by an aerosol deposition method, the area on which the fine particles in aerosol are hardly formed, than the other area on which aerosol is sprayed is called as a film-formation inhibitory (hindering) area. The plurality of film-formation inhibitory areas which are formed by the landing of droplets L are substantially circular shaped in a plan view (as seen from a direction orthogonal to one surface). Moreover, when a liquid which forms the droplets L has a property of being capable of staying at a landed position on the upper surface of the cavity plate 21, the step of curing (hardening) the droplets L may be omitted.

Next, as shown in FIGS. 7, 8A, and 9B, the vibration layer 41 is formed as a film (S103, film forming step) on the entire area on the upper surface of the cavity plate 21 by spraying aerosol including fine particles of a ceramics material (by the AD method). The vibration layer 41 is not necessarily required to be formed as a film on the entire upper surface of the cavity plate 21, and may be formed at least on the area facing the pressure chambers 10 and the through hole 9a (a predetermined area).

At this time, the fine particles of ceramics in the aerosol are deposited to form a film on a portion of the upper surface of the cavity plate 21 on which the droplets L are not landed, but the fine particles of ceramics in the aerosol, are not deposited to form a film on a portion of the upper surface of the cavity plate 21 on which the droplets L are landed (film-formation inhibitory area). Accordingly, the through holes 51 are formed in the portion of the vibration layer 41, facing the droplets L landed, and a portion of the vibration layer 41 facing the through hole 9a becomes the filter described above.

Moreover, since the vibration layer 41 is formed by the AD method, it is possible to decrease a thickness (about 5 μm for example) of the vibration layer 41, and accordingly, a depth of the through holes 51 can be decreased. Consequently, a channel resistance of the through holes 51 (filter) becomes small. Furthermore, since a diameter of each of the through holes becomes almost same as the diameter of the droplet L, it is possible to make small (to decrease) the diameter of the through holes 51 by landing the droplets L of small diameter (about 10 μm for example) on the upper surface of the cavity plate 21. Accordingly, it is possible to form easily a filter in which the through holes 51 each having small diameter are formed to remove small impurities.

Moreover, since the droplets L landed on the upper surface of the cavity plate 21 are substantially circular shaped in a plan view, a shape of openings of the through holes 51 also becomes substantially circular. In this manner, it is possible to form easily the filter having the substantially circular shaped through holes 51 by forming the vibration layer 41 by the AD method after making the droplets L land on the upper surface of the cavity plate 21.

Next, as shown in FIGS. 7 and 8B, the common electrode 43 is formed on the upper surface of the vibration layer 41 by a method such as a screen printing and a sputtering (S104), and as shown in FIGS. 7 and 9C, a mask M is arranged in an area in which the piezoelectric layer 42 is not arranged in FIG. 2, including a portion facing the through hole 9a on the upper surface of the vibration layer 41 (masking, S105). After carrying out one of the formation of the common electrode 43 (S104) and the arrangement of the mask M (S105), the remaining one may be carried out. Alternatively, both the formation of the common electrode 43 and the arrangement of the mask M may be carried out simultaneously.

Next, as shown in FIGS. 7, 8C, and 9D, the piezoelectric layer 42 is formed as a film on the upper surface of the vibration layer 41 by spraying aerosol including fine particles of a piezoelectric material (by AD method) (S106). Accordingly, the piezoelectric layer 42 is formed as a film on the upper surface of the vibration layer 41, except on a portion on which the mask M is arranged (avoiding the portion facing the through hole 9a). Moreover, in a case of forming the piezoelectric layer 42 as a film by the AD method, it is possible to form easily the piezoelectric layer 42 avoiding the portion facing the through hole 9a, by arranging the mask M before forming the piezoelectric layer 42 by the AD method in such manner. A combination of the step of arranging the mask M in S105 and the step of forming the piezoelectric layer 42 by the AD method in S106 corresponds to a piezoelectric layer forming step according to the present invention. Moreover, after forming the piezoelectric layer 42 as a film, as shown in FIG. 9E, the mask M is removed along with the piezoelectric layer accumulated on the upper surface thereof (S107).

Here, when the piezoelectric layer 42 is formed on the entire area on the surface of the vibration layer 41 without arranging the mask M before forming the piezoelectric layer 42 by the AD method, the piezoelectric layer 42 is formed on a portion of the upper surface of the vibration layer 41 facing the through hole 9a excluding the portions facing the through holes 51. Moreover, in this case, the stacked portion, of the vibration layer 41 and the piezoelectric layer 42, facing the through hole 9a acts as a filter. However, in this case, the depth of the through holes is more by the depth of the through holes formed in the piezoelectric layer 42, and a channel resistance of the through holes becomes substantial (increases).

Whereas, in the embodiment, since the piezoelectric layer 42 is formed avoiding the portion facing the through hole 9a, the piezoelectric layer 42 is not formed on the portion, of the upper surface of the vibration layer 41, facing the through hole 9a. Therefore, the depth of the holes of the filter does not become deep, and it is possible to reduce the channel resistance of the through holes.

Next, as shown in FIGS. 7, 8D, and 9F, the through hole 9a and the pressure chambers 10 cut through the cavity plate 21 are formed by removing parts of the cavity plate 21 (a portion facing at least a predetermined area) by etching (S108, removing step). At this time, the droplets L landed on the cavity plate 21 are also removed together with the cavity plate 21. Next, as shown in FIG. 8E, the individual electrodes 44 are formed on the upper surface of the piezoelectric layer 42 (S109). A combination of the step of forming the common electrode 43 described above and the step of forming the individual electrodes 44 corresponds to an electrode forming step according to the present invention.

Here, it is also possible to form the pressure chambers 10 and the through hole 9a by removing the parts of the cavity plate 21 by etching after the individual electrodes 44 are formed on the upper surface of the piezoelectric layer 42. However, in this case, there is a possibility that the individual electrodes 44 are damaged due to an etchant (etching reagent) coming in contact with the individual electrodes 44. Moreover, for preventing this, an extra step such as a step of masking the individual electrodes 44 before forming the pressure chambers 10 and the through hole 9a by etching becomes necessary.

However, in the embodiment, as it has been described above, since the individual electrodes 44 are formed on the piezoelectric layer 42 after the pressure chambers 10 and the through hole 9a are formed in the cavity plate by etching, the individual electrodes 44 are not damaged by an etchant, and a step such as a step of masking the individual electrodes 44 is not necessary.

Next, a stacked body of the cavity plate 21, the vibration layer 41, the common electrode 43, the piezoelectric layer 42, and the individual electrodes 44 is subjected to a heat treatment (for example, about 850° C.) (S110). By the heat treatment, annealing for imparting piezoelectric properties (characteristics) to the piezoelectric layer 42, and sintering (baking) of the common electrode 43 and the individual electrode 44 are carried out simultaneously. The annealing of the piezoelectric layer 42 is to be carried out by increasing (making large) a grain size of the piezoelectric material, for increasing a piezoelectric constant, and the sintering of the electrodes is to be carried out for fixing metal particles of the electrodes on the surface of the substrate (such as a piezoelectric layer and a vibration layer), and for joining surfaces of the metal particles with each other. In this manner, the terms ‘annealing’ and ‘sintering’ are clearly distinguished.

Here, when the heat treatment is carried out, constituent atoms of the cavity plate 21 made of a metallic material such as stainless steel (for example, Cr atoms when the cavity plate is made of stainless steel) are diffused (dispersed). Here, when the constituent atoms of the cavity plate 21 are dispersed to portions of the piezoelectric layer 42 facing the pressure chambers 10, the piezoelectric properties of the portions of the piezoelectric layer 42 are declined, and there is a fear that jetting characteristics of the ink from the nozzles when the piezoelectric actuator 32 is driven are declined.

However, in the embodiment, since the pressure chambers 10 are formed by removing the parts of the cavity plate 21, before carrying out the heat treatment, the constituent atoms of the cavity plate 21 are hardly diffused (dispersed) to the portions of the piezoelectric layer 42 facing the pressure chambers 10. Consequently, it is possible to suppress the decline in the piezoelectric characteristics of the portions of the piezoelectric layer 42 facing the pressure chambers 10.

Moreover, conversely to the embodiment, it is also possible to carry out the heat treatment before forming the individual electrodes 44 on the upper surface of the piezoelectric layer 42, and thereafter, to form the individual electrodes 44 on the upper surface of the piezoelectric layer 42. However, in the heat treatment, since only the annealing of the piezoelectric layer 42 and the sintering of the common electrode 43 are carried out, a step of sintering the individual electrodes 44 is separately necessary after the individual electrodes 44 are formed.

Whereas, in the embodiment, since the heat treatment is carried out after the individual electrodes 44 are formed on the upper surface of the piezoelectric layer 42, it is possible to carry out simultaneously the annealing of the piezoelectric layer 42 and the sintering of the common electrode 43 and the individual electrodes 44, and the process of producing the ink-jet head 3 can be simplified.

Thereafter, the cavity plate 21 which is prepared by the pressure chambers 10 and the through hole 9a being formed therein is joined to the other three plates 22, 23, and 24 forming the channel unit 31 which is prepared in advance (S112), and the ink-jet head 3 is completed.

According to the embodiment described above, the vibration layer 41 as a film is formed on the upper surface of the cavity plate 21 by the AD method after dropping the droplets L onto the upper surface of the cavity plate 21. Therefore, the film is formed on a portion of the upper surface of the cavity plate 21, excluding portions on which the droplets L are landed. Accordingly, the through holes are formed in the portions of the vibration layer 41 on which the droplets L are landed, and the portion of the vibration layer 41 facing the through hole 9a becomes a filter for removing impurities in the ink which might enter the ink supply channel 9.

Moreover, when the vibration layer 41 is formed as a film by the AD method, it is possible to form the thin vibration layer 41, and when the vibration layer is thin, a depth of the through holes 51 becomes small. Accordingly, it is possible to produce a filter having a small channel resistance as well as having a excellent filtering property.

Furthermore, since a diameter of the through holes 51 becomes almost the same as a diameter of the droplets L landed on the cavity plate 21, it is possible to form easily the through holes 51 having a small diameter by jetting the droplets L having a small diameter on the upper surface of the cavity plate 21. Accordingly, it is possible to form easily a filter having a small diameter of the through holes 51, which is capable of removing even the small impurities.

Moreover, since the through holes 51 are substantially circular shaped, a flow velocity of the ink flowing through the through holes 51 becomes uniform. Furthermore, the droplets L of an ultraviolet-curing resin landed on the upper surface of the cavity plate 21 become circular, and accordingly since the through holes 51 formed in the vibration layer 41 also becomes circular shaped, it is possible to form easily the through holes 51, of the filter, each having the substantially circular shaped.

Moreover, since the droplets L of the ultraviolet-curing resin landed on the upper surface of the cavity plate 21 are cured by irradiating the ultraviolet rays, it is easy to carry out a process thereafter. Furthermore, since an ultraviolet-curing resin is used as the droplets L, it is possible to cure (harden) easily the droplets L by irradiating the ultraviolet rays.

Moreover, since piezoelectric layer 42 is formed on the upper surface of the vibration layer 41, avoiding the portion facing the through hole 9a, the depth of the through holes forming the filter doesn't become deep, and the channel resistance of the through holes is not increased.

Since the piezoelectric layer 42 is formed as a film by the AD method after arranging the mask M on the upper surface of the vibration layer 41 at a portion facing the ink channel 9, it is possible to form easily the piezoelectric layer 42 avoiding the portion facing the through hole 9a without carrying out a control regarding a location where aerosol is sprayed.

Moreover, since the parts of the cavity plate 21 are removed by the etching, it is possible to form the pressure chambers 10 and the through hole 9a simultaneously, and steps forming the pressure chambers 10 and the through hole 9a become simple.

Next, modified embodiments in which various modifications are made in the embodiment will be described below. However, same reference numerals are assigned to components having a similar structure as in the above embodiment, and description of such components is omitted.

In the embodiment, the piezoelectric layer 42 is formed on the upper surface of the vibration layer 41 by the AD method after arranging the mask M on the portion, on upper surface of the vibration layer 41, facing the through hole 9a. However, the present invention is not restricted to such method. For instance, the mask M as described above may not be arranged. In this case, at the time of spraying aerosol of a piezoelectric material on the upper surface of the vibration layer 41 by the AD method, an apparatus (a unit) for spraying aerosol may be controlled such that aerosol is sprayed avoiding the portion facing the through hole 9a.

Moreover, in the embodiment, the piezoelectric layer 42 is formed by the AD method. However, the present invention is not restricted to this. For instance, it is also possible to form the piezoelectric layer 42 as a film by other method such as a sol-gel method, a sputtering method, a CVD method (chemical vapor deposition method), and a hydrothermal synthesis method. Or, the piezoelectric layer 42 may be formed by applying a liquid slurry which is made by mixing a material powder made of a sintering additive such as a piezoelectric material and glass, an organic binder, and a plasticizer with a solvent, on the upper surface of the vibration layer 41 on which the common electrode 43 is formed. Further, the piezoelectric layer 42 may be formed by joining a green sheet of a piezoelectric material to the upper surface of the vibration layer 41.

Moreover, in the embodiment, the droplets L of a ultraviolet-curing resin are jetted on to the upper surface of the cavity plate 21, and the droplets L landed on the upper surface of the cavity plate 21 are cured (hardened) by irradiating the ultraviolet rays. However, the present invention is not restricted to such method, and liquid droplets which can be cured (hardened) by a method other than irradiating the ultraviolet rays, such as heating, may be jetted.

Moreover, liquid droplets to be jetted on to the upper surface of the cavity plate 21 may not be of a material which is curable. Even in this case, when the vibration layer 41 is to be formed on the upper surface of the cavity plate 21 without moving the cavity plate 21 on which the liquid droplets are landed, the liquid droplets do not flow on the upper surface of the cavity plate 21, and the vibration layer 41 in which the through holes 51 are formed can be formed.

Furthermore, without restricting to jetting the liquid droplets on to the upper surface of the cavity plate 21, a plurality of film-formation inhibiting areas may be formed on the upper surface of the cavity plate 21 by other method such as masking the portions of the upper surface of the cavity plate 21 facing the through hole 9a, and carrying out a process such that fine particles in aerosol are hardly formed as a film on the portions of the upper surface of the cavity plate 21 facing the through holes 51. For instance, areas each of which a surface roughness is made substantial (increased) may be formed by performing the etching process or irradiating laser rays on the upper surface of the cavity plate 21, or, areas on which machine oil is applied may be formed. Such areas also function as the film-formation inhibiting area. Further, the shape of the through holes 51 may not be a circular shape.

Moreover, in the embodiment, the heat treatment for annealing the piezoelectric layer 42 and sintering the individual electrodes 44 and the common electrode 43 are carried out after forming the individual electrodes 44. However, order of carrying out the process is not restricted to such order, and after the pressure chambers 10 are formed in the cavity plate 21, the heat treatment for annealing the piezoelectric layer 42 and sintering the common electrode 43 may be carried out before forming the individual electrodes 44, and thereafter, the individual electrodes 44 may be formed on the upper surface of the piezoelectric layer 42, and a separate heat treatment may be carried out for sintering the individual electrodes 44.

Here, when sintering the electrodes (such as the individual electrode 44 and the common electrode 43) or sintering the vibration layer 41 is carried out separately from the annealing of the piezoelectric layer 42, it is possible to carry out the steps of sintering before forming the through holes, in the cavity plate 21, which become the pressure chambers. However, for preventing the piezoelectric properties (characteristics) of the piezoelectric layer from being declined due to the diffusion of the metal atoms contained in the cavity plate 21 to the piezoelectric layer 42, it is necessary to sinter at least at a temperature lower than the annealing temperature. Concretely, it is preferable to sinter the electrodes and the vibration layer 41 etc. at a temperature not more than 600° C. According to findings of the inventor of the present invention, when it is heated to a temperature higher than 600° C., the diffusion of metal atoms becomes remarkable, and there is a high possibility that the piezoelectric properties of the piezoelectric layer 42 are declined. It is preferable to sinter the electrodes and the vibration layer 41 at a temperature of not more than 500° C. According to the findings of the inventors of the present invention, even when heated to a temperature lower than 500° C., an effect of the diffusion of the metal atoms being small, there is a less possibility that the piezoelectric properties (characteristics) of the piezoelectric layer 42 are declined.

The cavity plate 21 is not restricted to be formed of a metallic material such as stainless steel, and may be formed of silicon. Even when atoms of silicon are diffused to the piezoelectric layer 42, the piezoelectric characteristics (properties) of the piezoelectric layer 42 are declined. But even in this case, at the time of heating the piezoelectric layer 42, since the portion of the piezoelectric layer 42 which becomes the pressure chamber 10 is removed, the atoms of silicon are hardly diffused to the portions of the piezoelectric layer 42 facing the pressure chambers 10 similarly as in the embodiment. Moreover, even when a substrate which becomes the cavity plate is made of silicon, it is possible to form easily through holes which form the pressure chambers and the ink supply channel by etching.

In the embodiment, in the piezoelectric actuator 32, the common electrode 32 is arranged on a lower surface of the piezoelectric layer 42, and the individual electrodes 44 are formed on the upper surface of the piezoelectric layer 42. However, the piezoelectric actuator may be an actuator in which electrodes are formed only on one of the upper surface and the lower surface of the piezoelectric layer 42.

In the embodiment, the pressure chambers 10 and the through hole 9a are formed simultaneously in the cavity plate 21 by etching. However, the pressure chambers 10 and the through hole 9a may be formed by other method such as a laser machining. Moreover, without restricting to form the pressure chambers 10 and the through hole 9a simultaneously, one of the through hole 9a and the pressure chambers 10 may be formed first, and the other one may be formed thereafter.

Moreover, in the embodiment, the cavity plate 21 is a substrate which is used for forming the filter. However, the substrate used for forming the filter may be different (separate) from the cavity plate 21. In this case, firstly, a plurality of film-formation inhibitory areas is formed on an upper surface of the substrate by jetting liquid droplets. Thereafter, a film is formed on an area (a predetermined area) in which at least the plurality of film-formation inhibitory areas are scattered, on the upper surface of the substrate, by the AD method, and thereafter, the filter is formed by removing a portion facing at least the predetermined area of the substrate. In this case, when the substrate is not a component which is to be used for an application other than producing the filter, the entire substrate may be removed after the film formation. Moreover, in this case, since the substrate is a component which is separate (different) from the cavity plate 21, a position of the filter is not restricted to a position as described in the embodiment.

In the abovementioned description, the present invention is applied to producing of an ink-jet head which jets an ink from nozzles connecting to the pressure chambers, and a filter which is used in this ink-jet head. However, the application of the present invention is not restricted to such application, and the present invention is also applicable to producing of a liquid jetting head which jets a liquid other than ink from the nozzles, and a filter which is used in this liquid jetting head, or to producing of a liquid transporting apparatus which transports a liquid inside liquid transporting channels including the pressure chambers by applying a pressure to the liquid inside the pressure chamber, and a filter which used in this liquid transporting apparatus.

Furthermore, the present invention is also applicable to producing of a filter for removing impurities in a liquid, other than the liquid transporting apparatus.

What is claimed is:

1. A method of producing a filter, comprising:
providing a substrate;
forming a plurality of film-formation inhibitory areas, one surface of the substrate, to be scattered in a predetermined area of the one surface, the film-formation inhibitory areas inhibiting a formation of a film which is formed of fine particles contained in aerosol when the aerosol containing the fine particles is blown onto the predetermined area;
forming the film with the fine particles on the one surface of the substrate by blowing the aerosol onto the predetermined area on the one surface of the substrate after the film-formation inhibitory areas are formed; and
removing a portion, of the substrate, facing the predetermined area after forming the film of the fine particles.

2. The method of producing the filter according to claim 1, wherein each of the film-formation inhibitory areas is circular shaped.

3. The method of producing the filter according to claim 2, wherein when the film-formation inhibitory areas are formed, the film-formation inhibitory areas are formed by landing a plurality of liquid droplets onto the one surface of the substrate.

4. The method of producing the filter according to claim 3, wherein the liquid droplets are curable.

5. The method of producing the filter according to claim 4, further comprising irradiating a light on the liquid droplets landed onto the one surface of the substrate, wherein the liquid droplets are photo-curable.

6. The method of producing the filter according to claim 3, wherein the liquid droplets have a diameter of approximately 10 μm when the liquid droplets are landed.

7. The method of producing the filter according to claim 1, wherein when the film-formation inhibitory areas are formed, a plurality of areas having a rough surface is formed on the one surface of the substrate by irradiating a laser ray on the one surface of the substrate.

8. The method of producing the filter according to claim 1, wherein a plurality of areas having a hardness lower than a hardness of the one surface of the substrate is formed, as the film-formation inhibitory areas, on the one surface of the substrate.

9. A method of producing a liquid transporting apparatus which includes a channel unit including a pressure chamber plate in which a pressure chamber having an opening formed on one surface of the pressure chamber plate, and a liquid channel having an opening formed on the one surface, and communicating with the pressure chamber are formed;
a piezoelectric actuator which applies a pressure to a liquid in the pressure chamber, and which includes a vibration layer covering the opening of the pressure chamber, a piezoelectric layer arranged on the vibration layer on a side not facing the pressure chamber, and an electrode which is arranged on a portion, of the piezoelectric layer, facing the pressure chamber; and
a filter which covers the opening of the liquid channel, and which removes impurities in the liquid to prevent the impurities from entering into the liquid channel,
the method of producing the liquid transporting apparatus comprising:
providing the pressure chamber plate;
forming a plurality of film-formation inhibitory areas on one surface of the pressure chamber plate to be scattered on an area, of the one surface, facing the liquid channel, the film-formation inhibitory areas inhibiting formation of a film which is formed of fine particles contained in an aerosol when the aerosol containing the fine particles is blown onto the one surface of the pressure chamber plate;
forming the vibration layer after the film-formation inhibitory areas are formed, by blowing the aerosol including the fine particles as a material forming the vibration layer, on the one surface of the pressure chamber plate, onto an area facing the pressure chamber and the liquid channel;
forming the pressure chamber and the liquid channel to penetrate through the pressure chamber plate, after the vibration layer is formed, by removing a part of the pressure chamber plate;
forming the piezoelectric layer on the vibration plate, on a side not facing the pressure chamber plate; and
forming the electrode on a portion, of the piezoelectric layer, facing the pressure chamber.

10. The method of producing the liquid transporting apparatus according to claim 9, wherein the piezoelectric layer is formed on the vibration layer so as to avoid a portion, of the vibration layer, which faces the liquid channel, and which is disposed on a side not facing the pressure chamber plate.

11. The method of producing the liquid transporting apparatus according to claim 10, wherein the piezoelectric layer is formed on the vibration layer by blowing an aerosol containing fine particles of a piezoelectric material on the vibration layer, on a side not facing the pressure chamber plate.

12. The method of producing the liquid transporting apparatus according to claim 11, wherein when the piezoelectric layer is formed, the aerosol containing the fine particles of the piezoelectric material is blown after masking a portion, of the vibration layer, which faces the liquid channel, and which is disposed on a side not facing the pressure chamber plate.

13. The method of producing the liquid transporting apparatus according to claim 9, wherein the pressure chamber and the liquid channel are formed simultaneously in the pressure chamber plate by removing the part of the pressure chamber plate by an etching.

14. The method of producing the liquid transporting apparatus according to claim 9, wherein the pressure chamber plate is formed of one of stainless steel and silicon.

15. The method of producing the liquid transporting apparatus according to claim 11, wherein the piezoelectric layer, the electrode, and the pressure chamber plate are heated to a temperature of about 850° C. after forming the piezoelectric layer, the electrode, the pressure chamber and the liquid channel.
